(19) United States
(12) Patent Application Publication
(10) Pub. No.: US 2008/0055645 A1
(43) Pub. Date: Mar. 6, 2008

(54) Computer readable medium, instructing apparatus, image processing system, image processing method, and computer data signal

(75) Inventors: Masatoshi Maruo, Kawasaki-shi (JP); Shigeki Muramatsu, Kawasaki-shi (JP)

Correspondence Address: SUGHRUE-265550, 2100 PENNSYLVANIA AVE. NW, WASHINGTON, DC, 20037-3213, US

(73) Assignee: Fuji Xerox Co., Ltd., Minato-ku (JP)

(21) Appl. No.: 11/730,984

(22) Filed: Apr. 5, 2007

(30) Foreign Application Priority Data
Aug. 31, 2006 (JP) 2006-235422

(51) Int. Cl. G06K 15/02

(52) U.S. Cl. 358/1.16

(57) ABSTRACT

A computer readable medium storing a program causing a computer to execute a process for creating a historical image, the process including: determining whether a processing unit, which performs an image processing to data including document data, can create a historical image representing a history of image processing performed on the document data; creating the historical image from the document data; and sending the document data and an instruction of the image processing, the instruction relating to the image processing performed on the document data, to the processing unit.

### CROSS-REFERENCE TO RELATED APPLICATIONS

This application is based on and claims priority under 35 U.S.C. 119 from Japanese Patent Application No. 2006-235442 filed Aug. 31, 2006.

### BACKGROUND

1. Technical Field

The present invention relates to a computer readable medium, to an instructing apparatus, to an image processing system, to an image processing method, and to a computer data signal.

2. Related Art

A printer system is known, which holds a picture image having been output from an output apparatus, such as a printer, and also having been actually printed on a recording medium, such paper, as a historical image together with accompanying information so that the image can be referred to later.

### SUMMARY

According to aspects of the invention, there are provided the following image processing programs, instructing apparatuses, and image processing system.

According to a first aspect of the present invention, a computer readable medium storing a program causing a computer to execute a process for creating a historical image, the process including: determining whether a processing unit, which performs an image processing to data including document data, can create a historical image representing a history of image processing performed on the document data; creating the historical image from the document data; and sending the document data and an instruction of the image processing, the instruction relating to the image processing performed on the document data, to the processing unit.

### BRIEF DESCRIPTION OF THE DRAWINGS

Exemplary embodiment of the present invention will be described in detail based on the following figures, wherein:

FIG. 1 is a block diagram illustrating the configuration of an image processing system according to an embodiment of the invention;

FIG. 2 is a block diagram illustrating the configuration of a client PC according to the embodiment of the invention;

FIG. 3 is a block diagram illustrating a historical image compliant printer according to the embodiment of the invention;

FIG. 4 is a block diagram illustrating a historical image noncompliant printer according to the embodiment of the invention;

FIG. 5 is a block diagram illustrating the configuration of a historical image management server according to the embodiment of the invention; and

FIG. 6A is a flowchart illustrating an operation of the image processing system according to the invention, and FIG. 6B is another flowchart illustrating an operation of the image processing system according to the embodiment of the invention.

### DETAILED DESCRIPTION

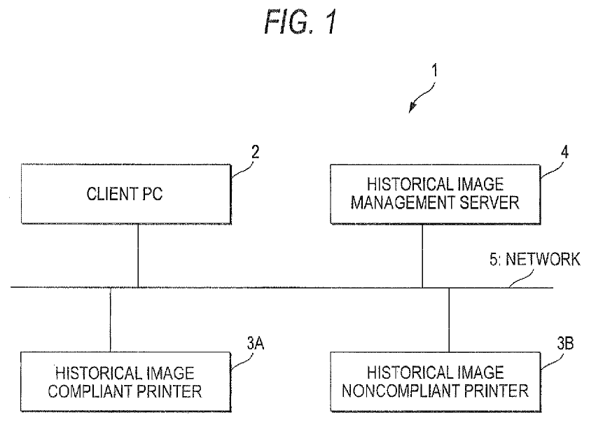

FIG. 1 illustrates an image processing system according to an embodiment of the invention. This image processing system 1 includes a client personal computer (hereunder referred to as a client PC) 2 (corresponding to the instructing apparatus) that creates a print job according to an image processing instruction and that sends the print job file to a printer. The image processing system 1 also includes a historical image compliant printer (corresponding to the processing unit) 3A which performs image processing according to a received print job file and has the function of creating a historic image, and a historical image noncompliant printer (corresponding to the processing unit) 3B which has the function of performing image processing according to a received print job file and does not have the function of creating a historic image, a historic image management server (corresponding to the management device) 4 which stores and manages historical images, a LAN (Local Area Network) connecting the client PC 2, the printers 3A and 3B, and the historical image management server 4 to one another, and a network 5 such as the Internet. Although FIG. 1 shows the single client PC 2, the single historical image compliant printer 3A, and the single historical image noncompliant printer 3B, each of the number of the client PCs 2, that of the historical image compliant printers 3A, and that of the historical image noncompliant printer 3B may be equal to or more than 2.

The “image processing instruction” is to instruct the processing unit (corresponding to the processing portion) to perform image processing. A practical example of the image processing is an operation of converting data, which is to be printed, into image processing data of the format (for example, PDL (Page Description Language)), which can be interpreted by the processing unit, and then creating a print job file by addition of data representing the processing to be performed thereon to this image processing data as instruction attributes, and sending the processing unit (corresponding to the processing portion) the print job file. The “job” means a process to be performed by a computer, or a part of the process. Jobs respectively performing the functions of copying, printing, scanning, facsimile-transmitting/receiving, and image-processing are referred to as a “copy job”, a “print job” (or “printing job”), a “scan job”, a “facsimile transmission/reception job”, and an “image processing job”. In the following description of the present embodiment, a print job is described, which is a sequence of operations of the printer from formation of an image on paper to discharge of the paper.

The “historical image” is created from an image processed in a print job as an executive log of the print job before, during, or after the print job is performed. In the following description of the present embodiment, the case of creating a historical image before the print job is performed. For example, an image created by reducing the number of pixels from the image processed in the print job, an image created from a color image through the conversion thereof by reducing the number of colors or that of gray scale levels, one or more images selected from a plurality of images created in the process of performing the print job, or all images printed in the print job.

The “processing units” include a compound machine, which has a plurality of functions, such as a copying function, a printing function, and facsimile facsimile-transmitting/receiving functions, a copying machine, a scanner, and a facsimile, in addition to the printers 3A and 3B.

### (Client PC)

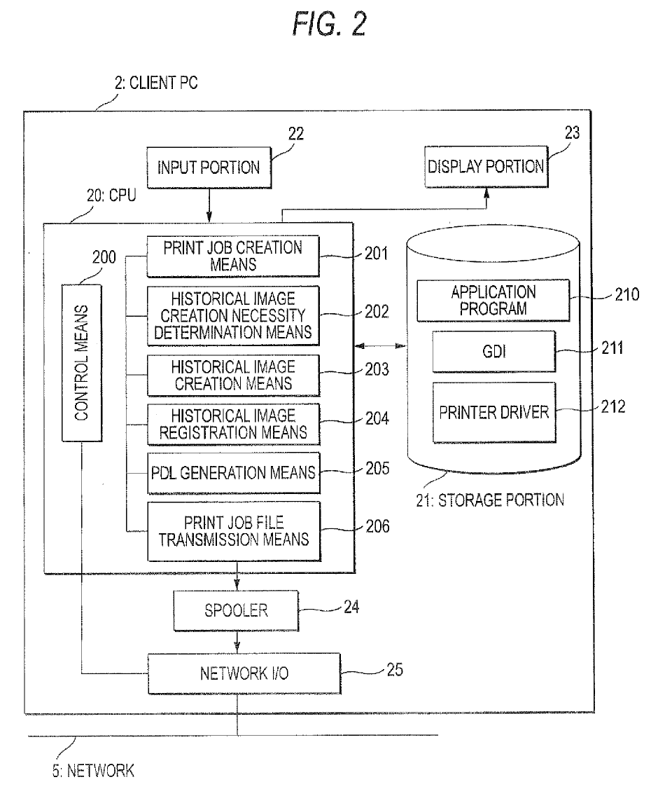

FIG. 2 is a block diagram illustrating the configuration of the client PC 2. The client PC 2 includes a CPU 20 configured to control each component of the PC 2, a storage portion 21 which includes a ROM, a RAM, and a HDD and is configured to store various programs and data, an input portion 22 configured to receive information input from input devices, such as a keyboard and a mouse, a display portion 23 configured to display setting-screen information in a Liquid Crystal Display (LCD), a spooler 24 in which a print job file is temporarily stored, and a network I/O 25 connected to the network 5.

The storage portion 21 stores application programs 210 which include a document creating program, and also stores programs such as a printer driver (corresponding to the image processing program) 212 adapted to drives the printer 3 and manages historical images, and a GDI (Graphics Device Interface) program adapted to pass information on instructions relating to print processing, which is sent from the application program 210, to the printer driver 212. In the present embodiment, the application program 210, the printer driver 212, and the GDI program 211 are separated from one another. However, all of these programs may be included in a single program. Alternatively, one of these programs may include other programs.

The CPU 20 functions as a control means 200 adapted to control each of components of the PC 2 by interpreting the programs such as the printer driver 212 stored in the storage portion 21 and also controlling data exchange among the means connected thereto, a print job creation means 201 adapted to create a print job, a historical image creation necessity determination means 202 adapted to determine the necessity for creation of a historical image, a historical image creation means 203 adapted to create a historical image, a historical image registration means 204 adapted to output and register a historical image to and in the historical image management server 4, a PDL generation means 205 adapted to generate PDL (Page Description Language) data, which can be interpreted by the printer 3, from job file data the application program 210 through the GDI program 211, and a print job transmission means 206 adapted to send a print job file, which includes PDL data and an instruction relating a print job, to the printer 3.

### (Historical Image Compliant Printer)

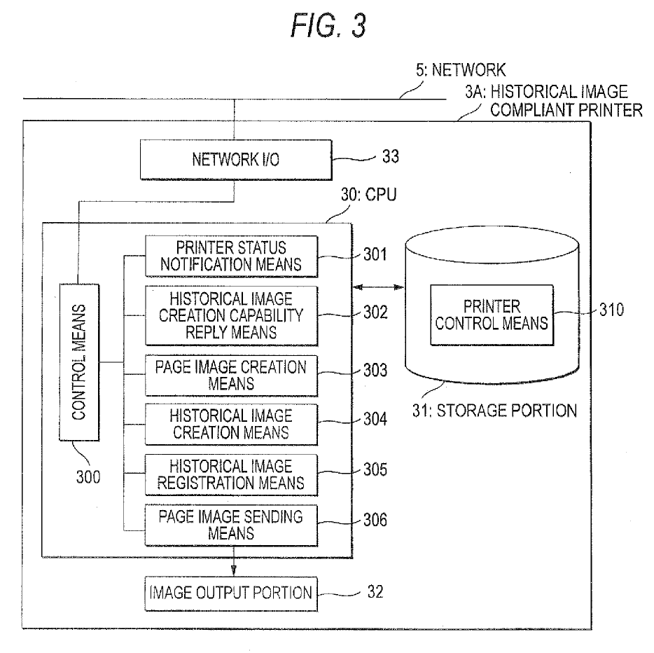

FIG. 3 is a block diagram illustrating the configuration of the historical image compliant printer 3A. The historical image compliant printer 3A includes a CPU 30 configured to control each of components of the printer 3A, a storage portion 31, such as a ROM, a RAM, and a HDD, adapted to store programs, such as a printer control program 310, and data, an image output portion 32, and a network I/O 33 connected to the network 5.

The CPU 30 operates according to a printer control program 310 stored in the storage portion 31 and functions as a control means 300 adapted to control each of components of the printer 3A, a printer status notification means 301 adapted to monitor and notify the status of the printer 3A, a historical image creation capability reply means 302 adapted to notify whether the printer 3A itself has the function of creating a historical image, a page image creation means 303 adapted to create a page image, which can be printed by the image output portion 32, from data included in a job file, a historical image creation means 304 adapted to create a historical image corresponding to a page image, a historical image registration means 305 adapted to output and register a historical image to and in the historical image management server 4, and a page image sending means 306 adapted to send a page image to the image output portion 32.

The image output portion 32 prints a page image output from the page image sending means 306 on a recording medium such as paper, and can employ various printing methods, such as an electrophotographic method, an inkjet method, and a thermal transfer method.

### (History Image Noncompliant Printer)

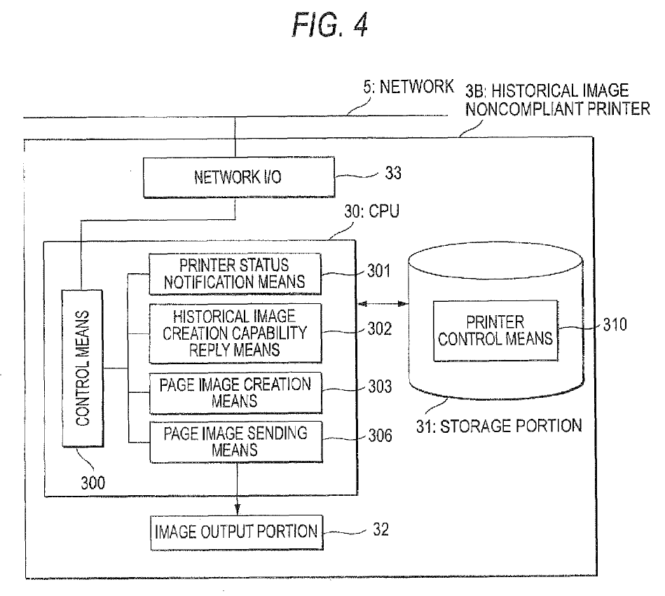

FIG. 4 is a block diagram illustrating the configuration of the historical image noncompliant printer 3B. The historical image noncompliant printer 3B includes a CPU 30 configured to control each of components of the printer 3B, a storage portion 31, such as a ROM, a RAM, and a HDD, adapted to store programs, such as a printer control program 310, and data, an image output portion 32, and a network I/O 33 connected to the network 5.

The CPU 30 of the historical image noncompliant printer 3B operates according to a printer control program 310 stored in the storage portion 31 and functions as a control means 300, a printer status notification means 301, a page image creation means 303, and a page image sending means 306, similarly to the historical image compliant printer 3A. However, the CPU 30 of the historical image noncompliant printer 3B does not have or function as a historical image creation capability reply means 302, a historical image creation means 304, and a historical image registration means 305. In a case where the CPU 30 of the historical image noncompliant printer 3B does not have a historical image creation capability reply means 302, the CPU 30 of the historical image noncompliant printer 3B has the function of replying, in response to an inquiry from the client PC 2 about the capability to create a historical image, that a historical image cannot be created.

### (Historical Image Management Server)

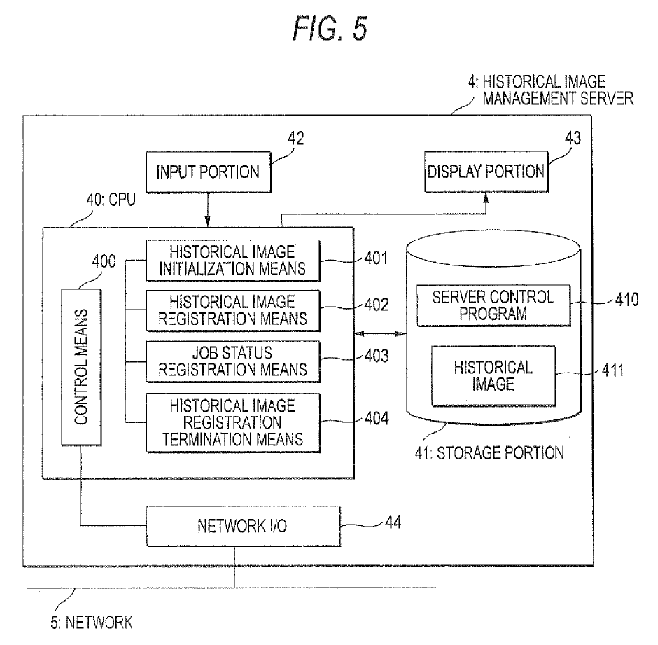

FIG. 5 is a block diagram illustrating the configuration of the historical image management server 4. The historical image management server 4 includes a CPU 40 configured to control each of components of the server 4, a storage portion 41, such as a ROM, a RAM, and a HDD, adapted to store various programs and data, an input portion 42 having a keyboard and a mouse, and a network I/O 44 connected to the network 5.

The storage portion 41 stores programs, such as a server control program 410, and a historical image 411 stored sent from the printer 3.

The CPU 40 operates according to a server control program 410 stored in the storage portion 41 and functions as a historical image initialization means 401 adapted to perform initialization at the registration of a historical image, for example, the sending-back of a historical image's identification value linking the historical image, which is an object to be registered, to a log stored in the storage portion 41 in response to a request for registration of a historical image, a historical image registration means 402 adapted to output and register a historical image corresponding to identification information on the historical image, a job status information registration means 403 adapted to register job status information corresponding to the identification information on a historical image, and a historical image registration termination means 404 adapted to release the identification information on a historical image at the termination of the registration of the historical image.

### (Operation of Image Processing System)

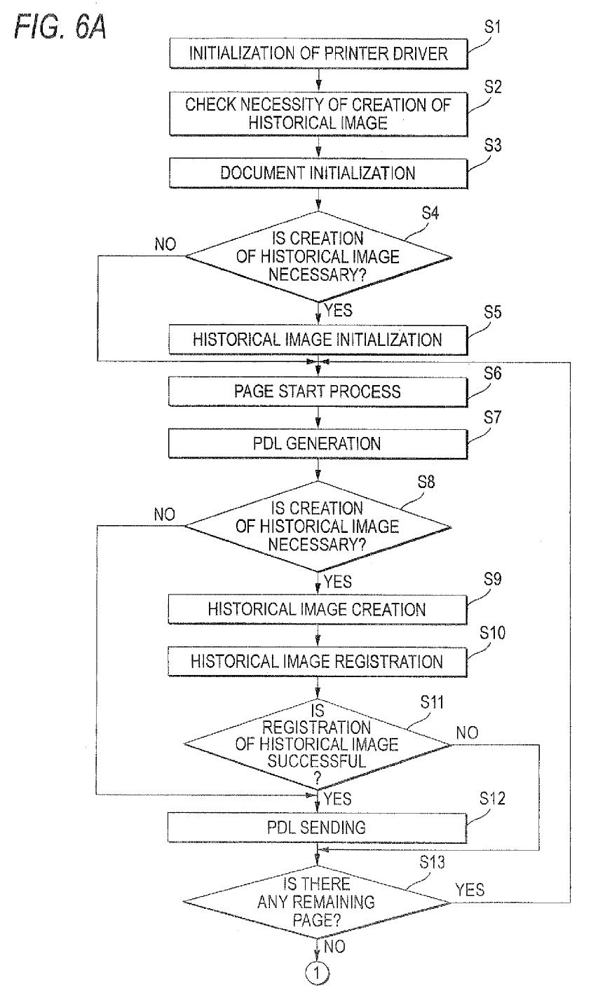

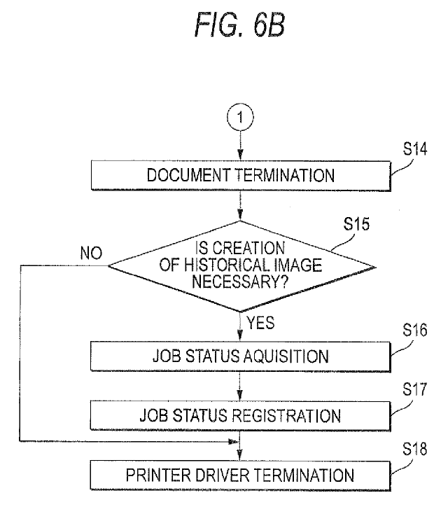

Next, an operation of the image processing system 1 according to the present embodiment is described below according to a flowchart illustrated in FIG. 6.

A user operates the input portion 22 of the client PC 2 to start an application program 210 stored in the storage portion 21. When the printing of document data created by the application program 210 is instructed, the CPU 20 causes the print job creation means 201 to generate a print job. Also, the CPU 20 generates job history data representing a job ID, a user name, and a job receipt time. When the printer driver 212 corresponding to the printer used to print an object is designated by a user, the control means 200 initializes the printer driver 212 in step S1.

The historical image creation necessity determination means 202 determines the necessity of creation of a historical image in step S2. That is, the historical image creation necessity determination means 202 inquires of the printer 3 corresponding to the printer driver designated in step S1 through the control means 200, the network I/O 25 and the network 5 whether the printer 3 can create a historical image. The historical image creation capability reply means 302 replies to the client PC 2 through the control means 300, the network I/O 33 and the network 5 whether the printer 3 has the function of creating a historical image. In a case where the reply is that the printer 3 has the function of creating a historical image, that is, where because the printer 3 can create a historical image, it is unnecessary for the client PC 2 to create a historical image, the historical image creation necessity determination means 202 sets a flag, which indicates that it is unnecessary for the printer driver to create a historical image, in a predetermined storage area of the printer driver 212.

Incidentally, in a case where an effective reply for determining the capability to create a historical image is not obtained from the printer 3 to which the inquiry is sent, or where the PC 2 receives a reply that the printer 3 cannot create a historical image, the flag, which indicates that it is unnecessary for the printer driver to create a historical image, is not set in the predetermined storage area of the printer driver 212. The case, in which no effective reply for determining the capability to create a historical image is obtained from the printer 3 to which the inquiry is sent, includes a case where the printer 3 has the function of creating a historical image, and where the printer 3 cannot perform the function of creating a historical image due to the facts that the printer 3 is busy, that a trouble occurs in the printer, or that the disk is full.

Subsequently, the control means 200 performs initialization of a document in step S3. Whether it is necessary to create a historical image is determined in step S4 from the status of the flag set in step S2. If necessary (Yes in step S4). The initialization of a historical image is performed in step 5. That is, the control means 200 of the client PC 2 calls the historical image initialization means 401 of the historical image management server 4 and acquires, when the historical image and the print job log corresponding to the job are registered in the historical image management server 4, identification information that is needed by the historical image management server 4 for identifying the job.

Next, the control means 200 specifies page information to be processed, which is contained in the job file. Then, the control means 200 performs a page start process in step S6. In a case where it is determined in step S4 that it is unnecessary to create a historical image (No in step S4), a page start process is performed in step S6 without performing the initialization of a historical image.

Subsequently, the PDL generation means 205 generates PDL data in units of pages from data contained in the received job file through the GDI program 211 from the application program 210.

In step S8, the control means 200 determines again from the status of the flag set in step S2 whether it is necessary to create a historical image. In a case where it is necessary to create a historical image (Yes in step S8), the historical image is output by the historical image registration means 204 and is registered in the historical image management server 4 in step S10 by being associated with the identification information obtained by the initialization. That is, the historical image registration means 204 sends the historical image to the historical image management server 4 through the control means 200, the network I/O 33 and the network 5. The historical image registration means 402 of the historical image management server 4 causes the storage portion 41 to store the historical image 411 sent from the client PC 2 by associating the historical image 411 with the identification information obtained by the initialization.

Next, when the control means 200 confirms that the registration of the historical image in the historical image management server 4 is successful (Yes in step S11), a print job file containing the PDL data and an instruction relating to the print job is sent in step S12 by the print job file sending means 206 to the printer S3 through spooler 24, the network I/O 25 and the network 5.

In a case where it is determined in step S8 that the creation of a historical image is unnecessary (No in step S8), the client PC 2 sends the print job file to the printer 3 in step S12 by neither creating a historical image in step S9 nor registering the historical image.

In a case where the registration of the historical image is unsuccessful in step S11 (No in step S11), the process advances to step S13 without sending the print job file in step S12.

When receiving the print job file, the page image creation means 303 of the printer 3 creates a page image from the PDL data, which is contained in the print job file, and also creates a historical image. The page image sending means 306 sends the page image to the image output portion 32 and also sends the historical image to the historical image management server 4. The image output portion 32 outputs the page image by printing the page image on a recording medium, such as paper

The control means 200 of the client PC2 determines in step S13 whether remaining pages to be processed are present in the job file. If Yes in step S13, the control means 200 goes to step S6 in which the page start process is performed. If No in step S13, the control means 200 performs document termination in step S14. Then, it is determined again in step S15 from the status of the flag, which is set in step S2, whether the creation of a historical image is necessary. If it is determined in step S15 (Yes in step S15) that it is necessary to create a historical image, job status information is acquired in step S16 according to a notification from the printer stature notification means 301 of the printer 3. Information on the job ID, a job start time, a job termination time, a user name, an account, and a job termination status may be used as the job status information.

The control means 200 causes the historical image management server 4 to register job status information therein in step S17 through the network I/O 25, and the network 5. The job status information registration means 403 of the historical image management server 4 causes the storage portion 41 to register the job status information according to the identification information by being associated with the historical image.

The control means 200 performs the termination of the printer driver 212 in step S18.

Incidentally, according to the above embodiment, in the case of the print job in which the printing has been performed, in order to assure that the historical image corresponding to this print job is surely registered in the historical image management server 4, the PDL data is output to the printer 3 only in a case where the historical image is sent to the historical image management server 4 before the output of the PDL data to the printer 3, and where the registration of the historical image is normally performed. However, according to this procedure, a step of creating and registering the historic image should be performed until the PDL data is output to the printer 3. Thus, it takes long time to obtain a result of printing, as compared with a printing operation in which no historic images are created.

Thus, sometimes, the historical image corresponding to the print job, which is processed by the printer 3 and is output on paper, is not necessarily registered in the historical image management server 4, because of, for example, occurrence of an error in a process of registering the historical image in the historical image management server 4. Assuming that such a case is allowed, the following procedure can be employed. That is, only operations of sending a print job file to the printer and storing the PDL data or printing instructions output from the application program are performed until the print job is terminated. Upon completion of performing the print job, a historical image is created according to the stored PDL data and the stored printing instructions sent from the application program. Then, the created historical image is sent to the historical image management server 4.

### Other Embodiments

The invention is not limited to the above embodiment. Various modifications can be made without departing from the spirit and scope of the invention.

The programs used in the above embodiment can be read from a recording medium, such as a CD-ROM, to the storage portion in the system. Alternatively, the programs used in the above embodiment can be downloaded from a server connected to a network, such as the Internet, to the storage portion in the system.

According to the above embodiment, the control means, the print job creation means, the historical image creation necessity determination means, the historical image creation means, the historical image registration means, the PDL generation means, the PDL sending means, the printer 3 and the historical image management server 4 are implemented by the CPU and the programs. A part or all of such means can be implemented by hardware, such as Application Specific Integrated Circuits (ASICs).

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A computer readable medium storing a program causing a computer to execute a process for creating a historical image, the process comprising:
determining whether a processing unit, which performs an image processing to data including document data, can create a historical image representing a history of image processing performed on the document data;
creating the historical image from the document data; and
sending the document data and an instruction of the image processing, the instruction relating to the image processing performed on the document data, to the processing unit.

2. The computer readable medium as claimed in claim 1, wherein, the creating of the historical image is performed in a case where it is determined that the processing unit can not create the historical image.

3. The computer readable medium as claimed in claim 1, further comprising:
outputting the history image created in the creating of the historical image to a management device.

4. The computer readable medium as claimed in claim 1, wherein the determining of whether or not the processing unit can create the historical image comprises:
inquiring of the processing unit whether or not the processing unit can create the historical image; and
determining that the processing unit can not create the historical image, in a case of not receiving a first response signal from the processing unit, the first response indicating that the processing unit can create the historical image, or a case of receiving a second response signal from the processing unit, % the second response signal indicating that the processing unit can not create the historical image.

5. The computer readable medium as claimed in claim 1, further comprising:
inhibiting creation of the historical image in the creating of the historical image in a case where it is determined that the processing unit can create the historical image.

6. An instructing apparatus comprising:
a determining unit that determines whether a processing unit, which performs an image processing to data including document data, can create a historical image representing a history of image processing performed on the document data;
a creating unit that creates the historical image from the document data; and
a sending unit that sends the document data and an instruction of the image processing to the processing unit, the instruction relating to the image processing performed on the document data.

7. The instructing apparatus as claimed in claim 6, wherein the creating unit creates the historical image in a case where the determining unit determines that the processing unit can not create the historical image.

8. The instructing apparatus as claimed in claim 6, further comprising:
a historical image output unit that outputs the history image created by the creating unit to a management device connected to the instructing apparatus.

9. The instructing apparatus as claimed in claim 8, wherein the determining unit inquires of the processing unit whether or not the processing unit can create the historical image, and determines that the processing unit can not create the historical image, in a case of not receiving a first response signal from the processing unit, the first response indicating that the processing unit can create the historical image, or a case of receiving a second response signal from the processing unit, the second response signal indicating that the processing unit can not create the historical image.

10. The instructing apparatus as claimed in claim 6, further comprising:
a control unit that inhibits creation of the historical image in a case where the determining unit determines that the processing unit can create the historical image.

11. An image processing system comprising:
an instructing apparatus comprising;
a determining unit that determines whether a processing unit, which performs an image processing to data including document data, can create a historical image representing a history of image processing performed on the document data;
a creating unit that creates the historical image from the document data in a case where the determining unit determines that the processing unit can not create the historical image; and
a sending unit that sends the document data and an instruction of the image processing to the processing unit, the instruction relating to the image processing performed on the document data;
a processing device that executes the image processing instruction sent from the sending unit of the instructing apparatus; and
a management device that includes a storage storing the historical image output from the history image output unit of the instructing apparatus.

12. An image processing method comprising:
determining whether a processing unit, which performs an image processing to data including document data, can create a historical image representing a history of image processing performed on the document data;
creating the historical image from the document data in a case where it is determined that the processing unit can not create the historical image; and
sending the document data and an instruction of the image processing, the instruction relating to the image processing performed on the document data, to the processing unit.

13. A computer data signal embodied in a carrier wave for enabling a computer to perform a process for image processing, the process comprising:
determining whether a processing unit, which performs an image processing to data including document data, can create a historical image representing a history of image processing performed on the document data;
creating the historical image from the document data in a case where it is determined that the processing unit can not create the historical image; and
sending the document data and an instruction of the image processing, the instruction relating to the image processing performed on the document data, to the processing unit.
